(19) United States
(12) Patent Application Publication
(10) Pub. No.: US 2020/0131449 A1
(43) Pub. Date: Apr. 30, 2020

(54) Additive Composition and Method for Preventing Fouling, Slagging, and Corrosion of Biomass Multi Fuel Fired or Dedicated Boilers Using Alumina

(71) Applicant: Blue Ocean Industry, Inc., Gunsan-si (KR)

(72) Inventor: Kwonho JEON, Seoul (KR)

(21) Appl. No.: 16/408,949

(22) Filed: May 10, 2019

(30) Foreign Application Priority Data
Oct. 30, 2018 (KR) 10-2018-0130326

(51) Int. Cl. C10L 10/04; C10L 10/06; C10L 5/40; F22B 37/02; F23J 7/00

(52) U.S. Cl. CPC C10L 10/04; C10L 10/06; C10L 2200/0469; F22B 37/025; F23J 7/00; C10L 5/40

(57) ABSTRACT

Provided is an additive composition and method for preventing fouling, slagging and corrosion of biomass multi fuel fired or dedicated boilers using alumina, and more particularly, to an additive composition capable of effectively preventing from fouling, slagging and corrosion of the inner wall of a biomass boiler and optimizing the thermal efficiency of power generation facilities by increasing the melting temperature of an inorganic material contained in the biomass fuel using alumina, and the additive composition may include 0.1 to 5 parts by weight of alumina (Al₂O₃) in respective of 100 parts by weight of fuels fed into biomass multi fuel fired or dedicated boilers.

### CROSS-REFERENCE TO RELATED APPLICATIONS

This application claims priority to and the benefit of Korean Patent Application No. 10-2018-0130326 filed in the Korean Intellectual Property Office on Oct. 30, 2018, the entire content of which is incorporated herein by reference.

### BACKGROUND OF THE DISCLOSURE

### 1. Field of the Disclosure

The present disclosure relates to an additive composition for preventing fouling, slagging, and corrosion of biomass multi-fuel fired or dedicated boilers using alumina, and more particularly, to an additive composition capable of effectively preventing fouling, slagging, and corrosion of the inner wall of a biomass boiler and optimizing the thermal efficiency of power generation facilities by increasing the melting temperature of an inorganic material contained in the biomass fuel using alumina.

### 2. Description of the Related Art

According to the Paris Climate Convention, each country is implementing a new renewable energy activation system to reduce carbon dioxide emissions and expand the market for new renewable energy and increase its competitiveness.

Biomass such as wood chips, wood pellets and palm oil shells, etc., are spotlighted as eco-friendly new renewable energy because it can reduce the amount of CO₂ generated due to the low sulfur content compared to conventional fuels. However, due to its significantly low calorie compared to that of the conventional fuels, when biomass is multi-fired with the conventional fuel, there are problems such as local heat imbalance due to difference in calorific value, decreased thermal efficiency and consequently, increased power generation cost.

Also, during multi-firing of biomass, minerals with low melting point in ash contained in biomass are melted in the combustion process, and the slagging and fouling phenomena which grow due to the flow of minerals and attached to the inner wall of the boiler and the heat exchanger, etc. are caused. These phenomena significantly reduce the heat efficiency of the boiler and interfere with the flow pattern in the combustion furnace. Furthermore, this can cause a problem of seriously damaging the inner wall of the boiler.

In addition, the strong alkaline components such as K₂O and Na₂O contained in the biomass are not only volatile but, also, have a short residence time in the boiler, thereby causing non-uniform combustion and coating the inner wall by reaction with the ashes in the combustion furnace. Thus, there is a problem in which the metal surfaces including the inner wall of the boiler become corroded, and therefore it is essential to solve the heat imbalance, slagging, fouling, and corrosion problems in the boiler during the multi-firing of the coal and biomass.

As a conventional technique for solving such a problem, Korean Patent No. 10-1542076 entitled “Combustion additive composition of solid fuel and method of using the same” discloses a combustion additive composition for a solid fuel comprising 0.1 to 20 parts by weight of a copper precursor and 10 to 300 parts by weight of a magnesium precursor, based on 100 parts by weight of water.

Korean Patent No. 10-0642146 entitled “Fuel additive composition for improving cold resistance and preventing slag and effectively removing clinker” discloses fuel additive composition composed of 30 to 86.98 weight % of a water-soluble solvent, 5 to 20 weight % of a continuous accelerator, 0.01 to 5 weight % of a stabilizer, 5 to 25 weight % of an alkali metal compound, 0.01 to 5 weight % of a metal compound and 3 to 15 weight % of a surfactant compound.

Korean Patent No. 10-1586430 entitled “Fuel additive composition for improving combustion ratio of pellets and coal fuel and incineration waste” discloses fuel additive composition composed of 5 to 15 parts by weight of hydrogen peroxide, 30 to 45 parts by weight of sodium hydroxide, 1 to 10 parts by weight of borax, 10 to 50 parts by weight of oxygen water, 2 to 5 parts by weight of glycerol, 1 to 3 parts by weight of a fatty acid ester, 2 to 5 parts by weight of a surfactant and 10 to 30 parts by weight of a ceramic ball, based on 100 parts by weight of sodium silicate.

However, all the above technologies are a necessary mechanism for the introduction into a thermal power plant boiler as a liquid phase additive, and it is difficult to expect the same effect when applied to a biomass boiler.

### SUMMARY OF THE DISCLOSURE

The present disclosure has been proposed in order to solve the above-mentioned problems, and it is an object of the present disclosure to provide an additive composition for fouling, slagging, and corrosion prevention of biomass multi-fuel fired or dedicated boilers using alumina capable of effectively preventing from fouling, slagging, and corrosion of the inner wall of a biomass boiler and optimizing the thermal efficiency of power generation facilities by increasing the melting temperature of an inorganic material contained in the biomass fuel using alumina by using alumina as an additive in form of solid powder.

According to an embodiment of the present disclosure for solving the problems, an additive composition for preventing fouling, slagging, and corrosion of a biomass multi-fuel fired boiler or a dedicated boiler using alumina, the additive composition may include 0.1 to 5 parts by weight of alumina (Al₂O₃) in respect to 100 parts by weight of biomass fuel injected into the biomass multi-fuel fired boiler or the dedicated boiler.

Also, the additive composition may further include 0.1 to 5 parts by weight of cinder.

In addition, the additive composition may further include 0.1 to 10 parts by weight of silica containing Al₂O₃ in respect to 100 parts by weight of biomass fuel, wherein silica containing Al₂O₃ is obtained from bauxite using the Bayer process during aluminum smelting.

According to another embodiment of the present disclosure, a method of preventing fouling, slagging, and corrosion of a biomass multi-fuel fired boiler or a dedicated boiler using alumina may include injecting an additive composition comprising 0.1 to 5 parts by weight of alumina (Al₂O₃) in respect to 100 parts by weight of fuel. The additive composition may further include 0.1 to 5 parts by weight of cinder.

In another embodiment, injecting of the additive composition increases a melting point of inorganic materials of biomass fuel.

In yet another embodiment, the melting point of inorganic materials is increased by chemical reaction (I):

(I) Al₂O₃·6SiO₂+2H₂O+2K(OH)−>Al₂O₃·6SiO₂·K₂O+3H₂O

In yet another embodiment, the melting point of inorganic materials is increased by chemical reaction (II):

(II) Al₂O₃·2SiO₂+2H₂O+2Na(OH)−>Al₂O₃·2SiO₂·Na₂O+3H₂O

### BRIEF DESCRIPTION OF THE DRAWINGS

FIG. 1 is a graph of potassium content in fly ash and bottom ash over time after, the addition of an additive composition for fouling, slagging, and corrosion prevention.

FIG. 2 shows the shape of the tube in the boiler before the addition of the additive composition for fouling, slagging, and corrosion prevention.

FIG. 3 shows the shape of the tube in the boiler after the addition of the additive composition for fouling, slagging, and corrosion prevention.

### DETAILED DESCRIPTION OF THE EMBODIMENTS

Hereinafter, the description of the present disclosure with reference to the drawings is not limited to a specific embodiment, and various modifications can be applied and various embodiments can be provided. Furthermore, it is to be understood that the following description covers all changes, equivalents, and alternatives falling within the scope of the spirit and technology of the present disclosure.

Furthermore, the singular expressions used in the present disclosure include a plurality of expressions unless the context clearly indicates otherwise. It is also to be understood that the terms “comprising”, “including” or “having” and the like are intended to designate the presence of features, integers, steps, operations, elements, components, or combinations thereof, and should not be construed to preclude the presence or addition of at least one other features, integers, steps, operations, elements, components, or combinations thereof.

In addition, in explaining the principle according to the examples of the present disclosure, a detailed description of known arts and configurations incorporated herein will be omitted when it may make the subject matter of the present disclosure unnecessarily unclear.

Hereinafter, an additive composition for fouling, slagging, and corrosion prevention of biomass multi-fuel fired or dedicated boilers using alumina according to an embodiment of the present disclosure will be described in detail.

The additive composition for fouling, slagging, and corrosion prevention of biomass multi-fuel fired or dedicated boilers using alumina according to an embodiment of the present disclosure may comprise 0.1 to 5 parts by weight of alumina (Al₂O₃) in respective of 100 parts by weight of fuels fed into biomass multi-fuel fired or dedicated boilers.

Herein, when the content of alumina is less than 0.1 part by weight, it is difficult to expect the effect as an additive for fouling, slagging, and corrosion prevention, and when it exceeds 5 parts by weight, economical efficiency may be reduced.

In addition, the additive composition for fouling, slagging, and corrosion prevention of biomass multi-fuel fired or dedicated boilers using alumina according to an embodiment of the present disclosure may further comprises 0.1 to 5 parts by weight of cinder, which is a by-product of a thermal power plant. That is, the cinder may be included in an amount of 0.1 to 5 parts by weight based on 100 parts by weight of the fuel injected into the biomass multi-fuel fired or dedicated boilers of the thermal power plant.

The cinder added to the fuel may contain the function of providing SiO₂ necessary for providing content and chemical bonding of alumina, and specifically, the content of alumina may be adjusted to about 25%. However, the above contents are illustrative and not restrictive.

Herein, if the content of the cinder is less than 0.1 part by weight, it is difficult to expect its role as an additive for preventing fouling, slagging, and the like and when the amount exceeds 5 parts by weight, the alumina content in the additive composition may be lowered and the fouling, slagging, and corrosion prevention effect may be reduced.

In addition, the additive composition for fouling, slagging, and corrosion prevention of biomass multi-fuel fired or dedicated boilers using alumina according to an embodiment of the present disclosure may further comprise 0.1 to 10 parts by weight of silica containing Al₂O₃, which is a residue obtained by collecting alumina from bauxite by the Bayer process in aluminum smelting.

When the Al₂O₃-containing silica is added to the biomass boiler, Al₂O₃ and SiO₂ can increase the melting point of the inorganic substance, thereby preventing slagging and fouling, etc., in the combustion furnace.

When the Al₂O₃-containing silica of less than 0.1 part by weight is added to 100 parts by weight of the fuel, it is difficult to expect the silica to serve as an additive for preventing fouling and slagging, and when the amount is more than 10 parts by weight, economical efficiency may be reduced due to an increase in the waste treatment cost by unreacted reaction with the alkali metal in the fuel and the boiler.

Hereinafter, the principle of the additive composition for fouling, slagging, and corrosion prevention of biomass multi-fuel fired or dedicated boilers using alumina according to an embodiment of the present disclosure will be described in detail.

Biomass fuels generally contain alkaline minerals such as K and Na. When K and Na are formed in the form of K₂O and Na₂O, respectively, they generate low melting temperatures (800° C. or below). Therefore, when the temperature of the combustion chamber is maintained at 800° C. or higher in the combustion process in the circulating fluidized bed boiler, the minerals in the fuel are discharged along the gas flow in its molten state and then hit the tube of the boiler to quickly freeze and coagulate so that it adheres to and deposits on the surface of the tube. Thus, the slagging and fouling phenomena obtained in this way dramatically reduces the thermal efficiency in the boiler.

In order to solve this problem, the present disclosure can increase the melting temperature of the inorganic substances contained in the biomass by injecting the alumina (Al₂O₃) additive composition into the combustion furnace, and the reaction formula thereof is as follows:

(1) Al₂O₃·6SiO₂+2H₂O+2K(OH)−>Al₂O₃·6SiO₂·K₂O+3H₂O

(Melting temperature of the ash is increased to about 1000° C.)

(2) Al₂O₃·2SiO₂+2H₂O+2Na(OH)−>Al₂O₃·2SiO₂·Na₂O+3H₂O

(Melting temperature of the ash is increased to about 1200° C.)

According to the above reaction formula, after the addition of the alumina additive composition, the melting temperature of the inorganic material in the biomass fuel is higher than the combustion temperature of the boiler, and the effect of chemically inhibiting the slagging and fouling phenomena caused by the molten inorganic material can be expected.

The cinder which can be further included in the additive composition of the present disclosure is a substance that has already undergone a combustion process in a thermal power plant boiler and remains as a solid component without being burnt when the additive composition is burned and circulates together with the ash. At this time, the circulating cinder has an effect of physically removing the existing clinker from the wall of the furnace, and an effect of peeling the clinker from the inner wall can also be expected because it is not petrified when attached to the inner wall of the boiler.

In addition, corrosion of the metal surface in the boiler is mainly formed at the contact points of the metal surface in the boiler by abutting the sediments forming the slagging and fouling. Therefore, reducing the slagging and fouling has the effect of suppressing the source of such corrosion.

Meanwhile, the additive composition for fouling, slagging, and corrosion prevention of biomass multi-fuel fired or dedicated boilers using alumina according to an embodiment of the present disclosure may be made of an aluminum by-product having the same effect as alumina.

Herein, the aluminum by-product is a by-product containing aluminum oxide (Al₂O₃), and 0.1 to 5 parts by weight of aluminum by-product may be added to 100 parts by weight of the fuel to be fed into the biomass multi fuel fired or dedicated boilers and the content of aluminum oxide may be 10 to 90%.

If the content of aluminum oxide is less than 10% for the same reason as the above-mentioned alumina, it is difficult to expect the effect as an additive for fouling, slagging and corrosion prevention, and if it exceeds 90%, the economic efficiency as an industrial by-product can be reduced.

In addition, the alumina and aluminum oxide by-products may each have particle sizes of 10 to 1500 μm. This is because when the particle size of the aluminum by-product is less than 10 μm, a sufficient reaction time in the furnace in the combustion furnace cannot be secured due to the floating phenomenon and it can be transferred to the end of the boiler cyclone. If the particle size exceeds 1500 μm, the effect of slagging and corrosion prevention can be reduced.

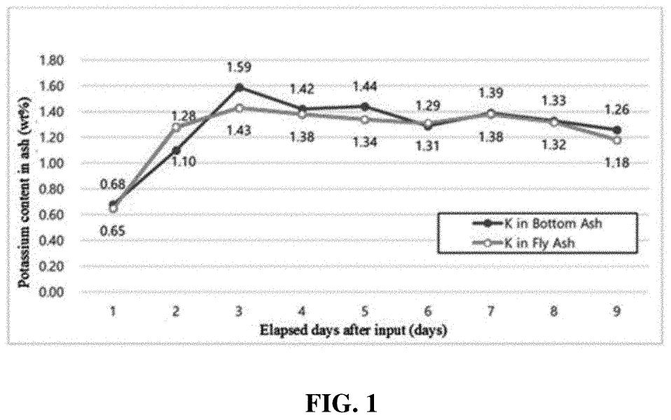

Hereinafter, the examples of additive composition for fouling, slagging, and corrosion prevention of biomass multi-fuel fired or dedicated boilers using alumina according to the present disclosure will be described in more detail with reference to FIG. 1 to FIG. 3, but it is not limited thereto.

### Experimental Example 1

To investigate the relationship between alumina (aluminum oxide, Al₂O₃) and potassium (K), a circulating fluidized bed thermal power plant boiler was charged with 919 tons of bituminous coal and 2,144 tons of wood pellets of fuel per day and 4 tons of alumina mean daily (0.131 parts by weight based on 100 parts by weight of fuel) and 5 tons of cinder of thermal power plant (0.163 parts by weight based on 100 parts by weight of fuel) were charged and operated for 9 days on mean daily for 22 hours.

In the suppression effect of slagging and fouling in the boiler, the higher the content of alkaline components such as K and Na in fly ash and bottom ash discharged to the outside of the boiler, the lower the alkali content deposited and attached in the form of slagging and fouling in the boiler, and it can be interpreted that slagging and fouling are suppressed.

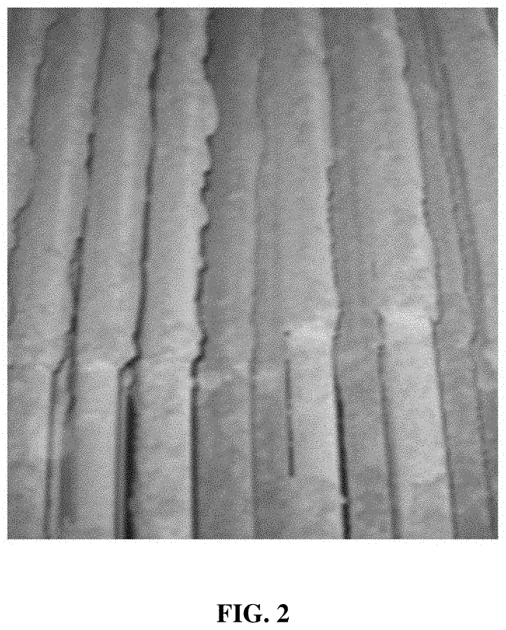

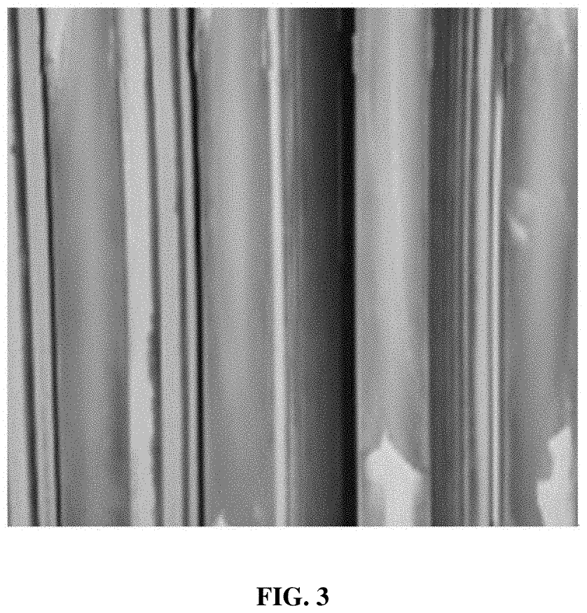

The graph of potassium content in fly ash and bottom ash in Experimental Example 1 are plotted in FIG. 1 and the photographs before and after the experiment for a total of 9 days of Experimental Example 1 are shown in FIG. 2 and FIG. 3, respectively.

### Experimental Example 2

In order to examine the adequate amount of alumina for the fuel, a mean daily of 900 tons of bituminous coal and 2,100 tons of wood pellets of fuel (total 3000 tons of fuel) and alumina were added to five of circulating fluidized bed thermal power plant boilers differently in the following Examples 1 to 4 and Comparative Example 1, the effects on fouling, slagging, and corrosion prevention were measured.

The measurement was conducted under the same conditions as in Examples 1 to 4 and Comparative Example 1, and the boiler was operated for 4 weeks on a mean daily for 22 hours and the inside of the boiler was visually inspected to determine the respective incidence rate of fouling, slagging, and corrosion to check as: very low, low, medium, high, and very high. The results are shown in Table 1 below.

### Example 1

1.5 tons of alumina was added to 3000 tons of fuel. (0.05 parts by weight of alumina in respect of 100 parts by weight of fuel)

### Example 2

3 tons of alumina was added to 3000 tons of fuel. (0.1 part by weight of alumina in respect of 100 parts by weight of fuel)

### Example 3

150 tons of alumina was added to 3000 tons of fuel. (5 parts by weight of alumina in respect of 100 parts by weight of fuel)

### Example 4

165 tons of alumina was added to 3,000 tons of fuel. (5.5 parts by weight of alumina in respect of 100 parts by weight of fuel)

### Comparative Example 1

No alumina added in respect of 3000 tons of fuel

TABLE 1

| | | | | | Comparative |
|---|---|---|---|---|---|
| | Example 1 | Example 2 | Example 3 | Example 4 | Example 1 |
| Fouling | Very high | High | Low | Low | Very high |
| Slagging | Very high | Medium | Very low | Very low | Very high |
| Corrosion | High | Medium | Low | Low | Very high |

As shown in Table 1, the improvement of fouling, slagging, and corrosion in Example 2 was not remarkably increased in comparison with the Comparative Example 1, but it was found to be effective. Example 3 can be confirmed that a remarkable effect is obtained compared with Comparative Example 1.

In addition, the improvement effect in Example 1 is extremely small compared with Comparative Example 1, and in the case of Example 4, there is no difference in the effect compared with Example 3.

Accordingly, it can be confirmed that the effect of fouling, slagging, and corrosion has in case of the addition of the amount of the adjacent range between Example 2 and Example 3 (between 0.1 and 5 parts by weight of alumina based on 100 parts by weight of fuel).

An additive composition for fouling, slagging, and corrosion prevention of biomass multi-fuel fired or dedicated boilers using alumina according to an embodiment of the present disclosure can effectively prevent from fouling, slagging and corrosion of the inner wall of a biomass boiler and optimize the thermal efficiency of power generation facilities by increasing the melting temperature of an inorganic material contained in the biomass fuel using alumina.

While the present disclosure has been particularly shown and described with reference to exemplary embodiments thereof, it will be understood by those skilled in the art that various changes in form and details may be made therein without departing from the spirit and scope of the disclosure. Accordingly, the embodiments described above are to be considered in all respects as illustrative and not restrictive.

What is claimed is:

1. An additive composition for preventing fouling, slagging, and corrosion of a biomass multi-fuel fired boiler or a dedicated boiler using alumina, the additive composition comprising:
0.1 to 5 parts by weight of alumina (Al₂O₃) in respect to 100 parts by weight of biomass fuel injected into the biomass multi-fuel fired boiler or the dedicated boiler.

2. The additive composition of claim 1, further comprising 0.1 to 5 parts by weight of cinder.

3. The additive composition of claim 1, further comprising 0.1 to 10 parts by weight of silica containing Al₂O₃ in respect to 100 parts by weight of biomass fuel, wherein silica containing Al₂O₃ is obtained from bauxite using the Bayer process during aluminum smelting.

4. A method of preventing fouling, slagging, and corrosion of a biomass multi-fuel fired boiler or a dedicated boiler using alumina, the method comprising:
injecting an additive composition comprising 0.1 to 5 parts by weight of alumina (Al₂O₃) in respect to 100 parts by weight of fuel.

5. The method of claim 4, wherein the additive composition further comprises 0.1 to 5 parts by weight of cinder.

6. The method of claim 4, wherein the additive composition further comprises 0.1 to 10 parts by weight of silica containing Al₂O₃, and wherein silica containing Al₂O₃ is obtained from bauxite using the Bayer process during aluminum smelting.

7. The method of claim 4, wherein injecting of the additive composition increases a melting point of inorganic materials of biomass fuel.

8. The method of claim 7, wherein the melting point of inorganic materials is increased by chemical reaction (I):
(I) Al₂O₃·6SiO₂+2H₂O+2K(OH)−>Al₂O₃·6SiO₂·K₂O+3H₂O

9. The method of claim 7, wherein the melting point of inorganic materials is increased by chemical reaction (II):
(II) Al₂O₃·2SiO₂+2H₂O+2Na(OH)−>Al₂O₃·2SiO₂·Na₂O+3H₂O
